(19) United States
(12) Patent Application Publication
(10) Pub. No.: US 2007/0230174 A1
(43) Pub. Date: Oct. 4, 2007

(54) ILLUMINATED ARTIFICIAL TREE

(76) Inventors: Larry O. Hicks, Dallas, TX (US); David Allen Hicks, Harrisburg, NC (US)

Correspondence Address: Michael A. O'Neil;Michael A. O'Neil, P.C., Suite 820, 5949 Sherry Lane, Dallas, TX, 75225, US

(21) Appl. No.: 11/691,915

(22) Filed: Mar. 27, 2007

Related U.S. Application Data
(60) Provisional application No. 60/744,150, filed on Apr. 3, 2006.

(51) Int. Cl. F21S 13/14

(52) U.S. Cl. 362/252

(57) ABSTRACT

An illuminated artificial tree having a center pole with mounts thereon for receiving and supporting branches about the center pole and means for providing electricity to electrical lighting about each branch individually so that the electrical lighting about each individual branch can be replaced without affecting the electrical lighting about the other branches.

### CROSS-REFERENCE TO RELATED APPLICATION

Applicant claims priority based on provisional patent application Ser. No. 60/744,150 filed Apr. 2, 2006, the entire content of which is incorporated herein by reference.

### TECHNICAL FIELD

This invention relates to the fields of electrical lighting and artificial trees.

### BACKGROUND AND SUMMARY OF THE INVENTION

It is common and well known to illuminate trees, particularly artificial trees. It is especially common for individuals to seek to illuminate artificial trees during the Christmas season.

Artificial trees are often illuminated by wrapping strings of electrical lights about the branches thereof. Typically, numerous strings of electrical lights are required, each string being plugged into the next to form a long, single string of electrical lights that is plugged into an electrical wall outlet. If a large number of strings of lights is used it may be necessary to form multiple long strings that are each plugged continuously end to end into each other and into a wall outlet in order to provide sufficient current to power the lights.

It is extremely time consuming to illuminate artificial trees in the manner described above. To achieve the appearance of a fully illuminated artificial tree each branch must be manually wrapped with electrical lights. A string of electrical lights is wrapped about branches until the entire length of the string is utilized, and then the string is plugged into another string that is similarly wrapped manually about branches, and so on until all the branches of the tree are covered.

In addition to the extended amount of time required to illuminate a tree as described above, it is common for one string of electrical lights to fail when multiple strings of lights are connected. This requires that the beginning and ending of the failed string be located, the string removed from the tree, and a new string put in its place. The replacement process is time consuming as well. Further, because the strings of electrical lights are connected one to another it is common for the failure of one string to affect other strings as well.

There are also safety hazards associated with connecting multiple strings together. Often an electrical extension cord is used to plug the multiple strings into an electrical outlet. Although most extension cords are only rated for a certain electrical load many consumers are unaware of such load restrictions and the hazards associated with failing to practice such restrictions. Overloading electrical extension cords can result in fires resulting in property damage and ultimately loss of life if a fire occurs in a building where any occupants are unable to escape.

It is also well known for artificial trees to be pre-lit wherein strings of lights are placed about the branches during manufacture. Heretofore the strings of lights on pre-lit artificial trees have been connected one to another such that the problem of replacing failed strings is not avoided. In addition to failed strings of lights such trees generally require a significant amount of space for storage when not in use and/or can be very cumbersome and difficult to assemble and dis-assemble.

The present invention addresses the foregoing and other difficulties which have long since been associated with the prior art of illuminating artificial trees. In accordance with the broader aspects of the invention the invention comprises a center pole and a plurality of branches that are attached to and supported by the center pole. The center pole encloses at least one electrical power cord that supplies power to various predetermined points along the length of the center pole. Each of the predetermined points comprises a mounting fixture that supports a number of branches located at spaced intervals about the center pole.

Each mounting fixture comprises a number of cavities each for receiving a branch and suppling electrical power to the branch via electrical contacts located within each cavity. Each branch comprises a boot at the proximal end thereof for engaging the cavity and securing the branch within the cavity. Each boot comprises electrical contacts which engage the electrical contacts within the cavity thereby completing the electrical connection from the power cord within the center pole to the boot of each branch.

Each branch has a string of electrical lights attached therearound. Each string of lights comprises a first fusible link plug which plugs into a matching plug located on the boot. The matching plug on the boot supplies power to the string of lights once the boot is engaged in the cavity. The string of lights on each branch is independent from any string of lights on other branches; therefore, a failure of one string of lights on one branch does not affect any other string of lights on the tree. In addition to not causing any other lights on other branches to fail, each branch can be individually removed from the tree for replacement of the string of lights without removing any other branches or lights from the tree resulting in a much easier and less time-consuming process to replace lights than the time or effort required in the prior art.

### BRIEF DESCRIPTION OF THE DRAWINGS

A more complete understanding of the present invention may be had by reference to the following Detailed Description when taken in connection with the accompanying Drawings, wherein:

FIG. 1 is a perspective view illustrating the method of applying lights to artificial trees in the prior art;

FIG. 2 is a cross-sectional view of an illuminated artificial tree comprising one embodiment of the invention;

FIG. 3 is a perspective view of a branch being attached to a mount in the embodiment illustrated in FIG. 2;

FIG. 4 is a perspective view of the top and bottom halves of the center pole in the embodiment illustrated in FIG. 2;

FIG. 5 is a perspective view of the connected center pole in the embodiment illustrated in FIG. 2;

FIG. 6 is a cross-sectional view of a mount in the embodiment illustrated in FIG. 2; and

FIG. 7 is a perspective view of the top piece of the embodiment illustrated in FIG. 2.

### DETAILED DESCRIPTION

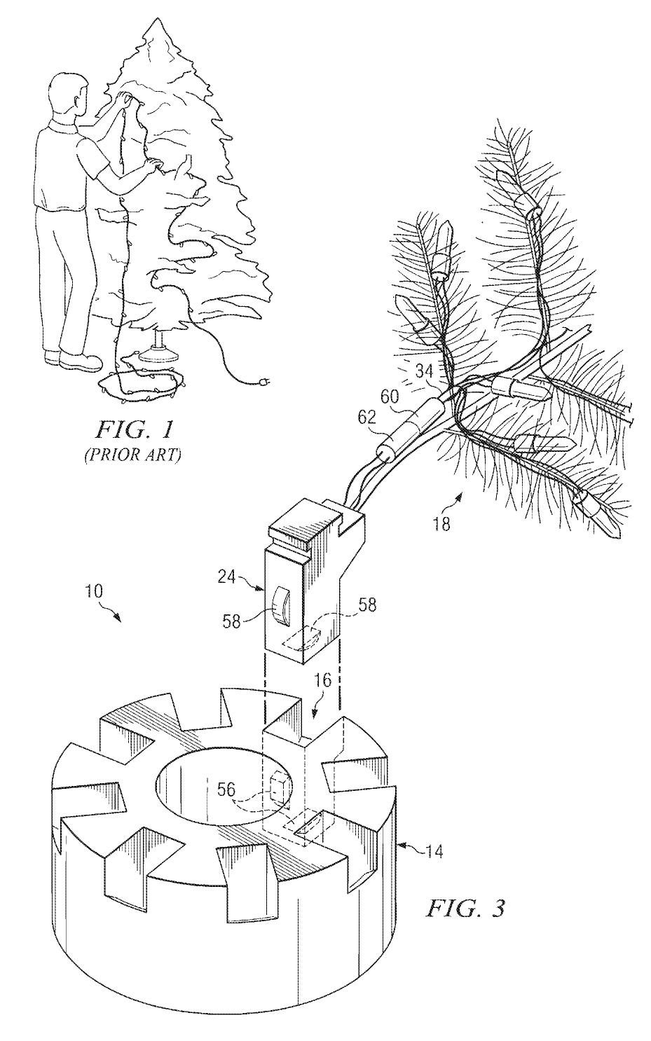

Referring to the drawings, and in particular to FIG. 1, there is shown a perspective view of an individual attempting to illuminate an artificial tree in the prior art. The difficulties encountered in the prior art include isolating branches, individually wrapping isolated branches with strings of electrical lights, isolating a string of electrical lights that has failed once failure becomes apparent, and the effect of failed strings of lights on other strings.

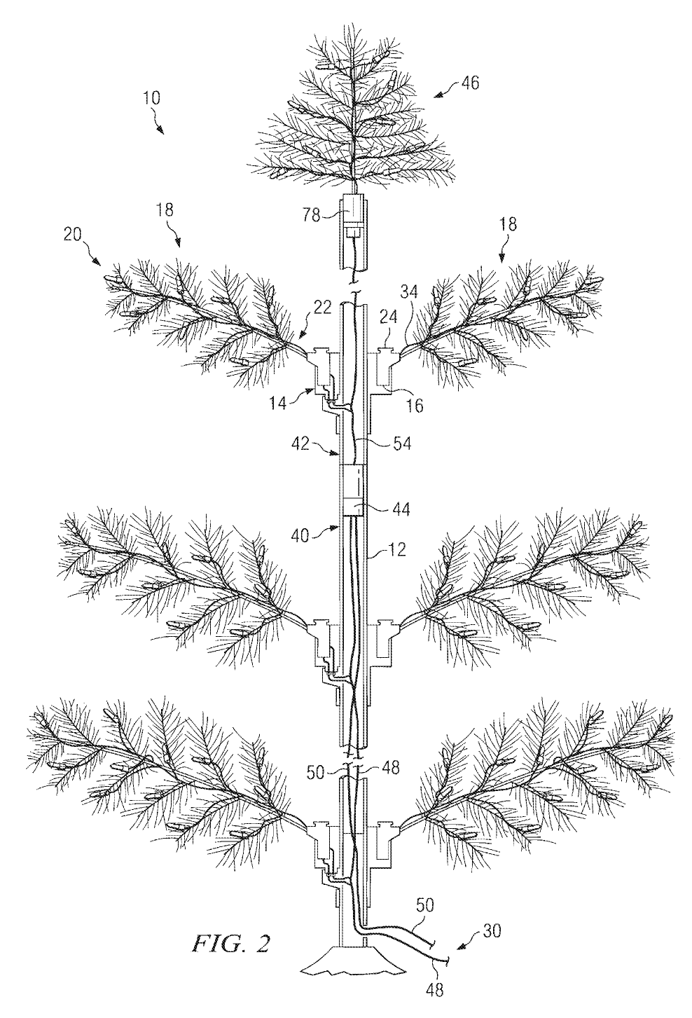

Referring now to FIG. 2 there is shown an artificial illuminated tree 10 comprising one embodiment of the invention. The tree 10 comprises a center pole 12 having a plurality of mounts 14 supported thereon, each mount 14 comprising multiple cavities 16 for receiving branches 18 therein. Each branch 18 comprises a distal end 20 and a proximal end 22, the proximal end 22 comprising a boot 24 for securing the branch 18 into one of the cavities 16 of the mount 14. Electrical power is provided to each individual cavity 16 via a power cord system 30 comprising a plurality of power cords and wires located within and throughout the center pole 12. Electrical lights 34 strung around the branch 18 plug into the boot 24 which receives power from the cavity 16. Each cavity 16 supplies electrical power only to the branch 18 received therein and each string of lights 34 is independently plugged into the boot 24 of a branch 18, so each branch 18 and string of lights 34 about each branch 18 is therefore independent of other branches 18 and lights on the tree 10.

The center pole 12 may comprise one continuous section or multiple sections in the construction thereof. The embodiment shown in FIG. 2 comprises two sections, a bottom portion 40 and a top portion 42, coupled together by a plug 44 and having a tree-top 46 coupled to the top portion 42. As is understood by those skilled in the art, the tree 10 may be configured with additional sections according to the desired height of the tree. For the tree 10 comprising two sections, the power cord system 30 comprises at least three power cords for providing power to the sections of the center pole 12. A first power cord 48 supplies power within the bottom portion 40, a second power cord 50 supplies power to the plug 44 that connects the bottom portion 40 to the top portion 42, and a third power cord 54 supplies power within the top portion 42 and the tree-top 46.

Referring now to FIG. 3, there is shown a perspective view of one of the mounts 16 that is secured about the center pole 12. Completing the electrical connection between the cavity 16 and the branch 18 are recessed electrical contacts 56 in the cavity which receive and engage electrical contacts 58 of the boot 24. The electrical contacts 58 of the boot 24 are spring-loaded such that when the boot 24 is inserted into the cavity 16 the electrical contacts 58 of the boot 24 spring outward and engage the recessed electrical contacts 56 of the cavity 16 once the boot 24 is fully received into the cavity 16. The spring-loaded contacts 58 and recessed receiving contacts 56 safeguard against any accidental electrical or physical injuries during assembly and disassembly of the branch 18 with the cavity 16. For example, a child will be unable to remove the branch from the cavity without supervision. In addition, having the contacts 56 and 58 recessed in the cavity 16 prevent a child or anyone from inserting fingers or other small items between the contacts.

In an alternate embodiment, a conductive metallic ring may be coupled about the center pole 12 to provide electrical contact between the power cord system and the electrical contacts of the boot.

Each string of electrical lights 34 comprises a first fusible link plug 60 at one end thereof for engaging a second plug 62 extending from the boot 24. When the electrical contacts 58 on the boot 24 engage the recessed contacts 56 within the cavity 16, current is passed through the boot 24 and onto the string of electrical lights 34 wrapped around the branch 18. The mount 14 shown in FIG. 3 has eight cavities 16 but as will be understood by those skilled in the art, the mounts 14 may be configured with varying numbers of cavities 16 to receive more or fewer branches 18 according to the mount's location on the center pole 12.

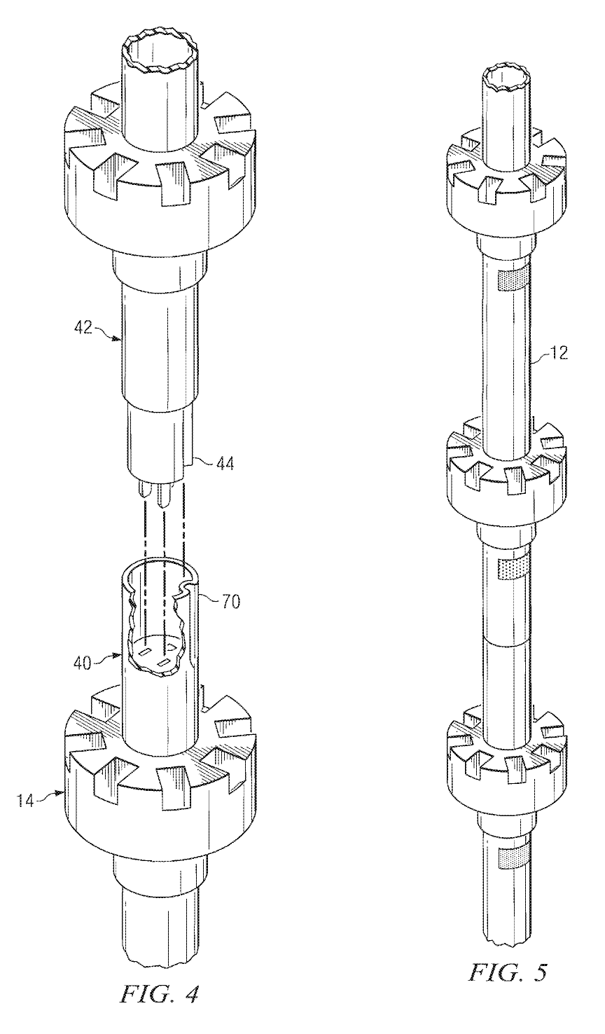

Referring now to FIG. 4, there is shown a perspective view of the plug 44 connecting into a female receptacle on the bottom portion 40 of the center pole 12 to the top portion 42. A sleeve 70 provides additional stability to the connection between the bottom portion 40 and top portion 42 and a safety covering over the plug 44. The sleeve 70 about the plug 44 prevents the plug 44 from being unplugged by a child, pet, or someone unaware of the hazards, both electrical and physical, that may be encountered if removing the plug 44 without supervision. In addition, the sleeve 70 prevents a child or anyone from inserting fingers or other small objects into the plug 44.

FIG. 5 is a perspective view of center pole 12 showing the bottom portion and the top portion of the center pole connected together.

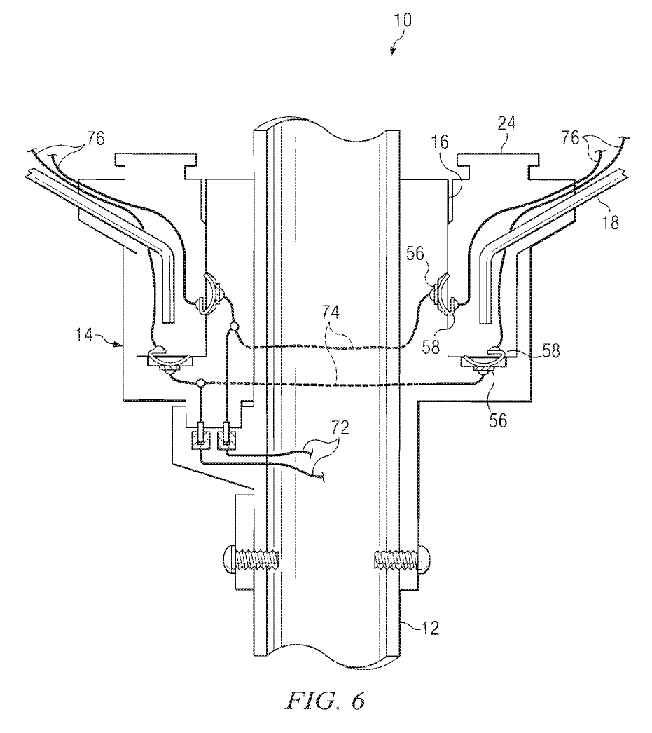

FIG. 6 is a cross-sectional view of a mount 14 located about the center pole 12 and the electrical connections therein. The electrical contacts 56 of each cavity 16 are connected with the power cord system 30 via a first set of wiring 72 extending from the mount 14 into one cavity 16 in the mount 14. The other cavities 14 within the mount are connected with additional wiring 74 that runs between and connects all of the cavities 16 of the mount. The second plug 62 extending from the boot 24 receiving the fusible link plug 60 from a string of lights 34 is connected with the electrical contacts 58 of the boot by wiring 76 extending through the boot 24.

As shown in FIG. 6 the boot 24 may be molded as an integral part of the proximal end 22 of the branch 18. Alternatively, the boot 24 may be coupled with the branch 18 such that the proximal end of the branch may be removable from the boot 24.

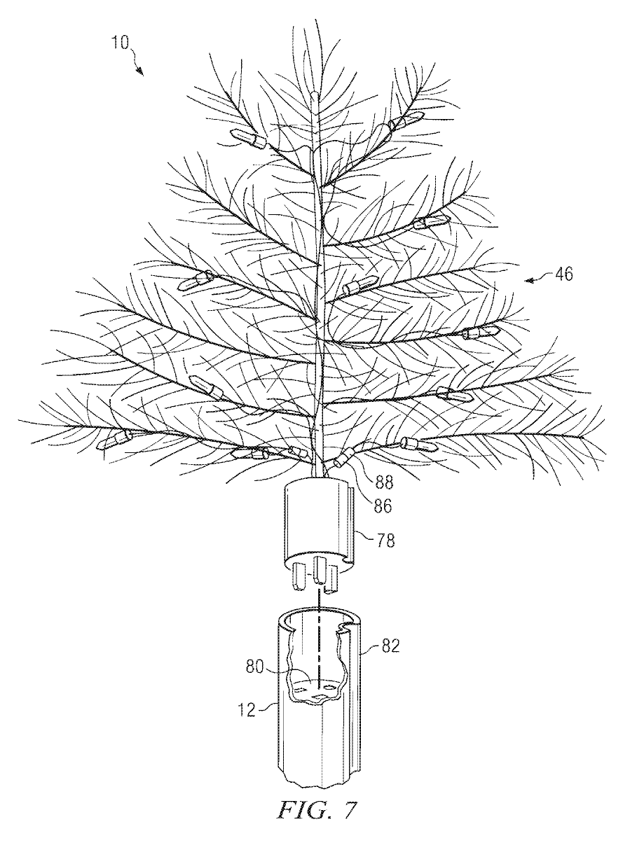

FIG. 7 is a perspective view of the tree-top 46 that attaches atop the center pole 12. The tree-top 46 couples to the center pole 12 by a plug 78 which is received into a female outlet 80 recessed in a sleeve 82. The sleeve 82 provides additional stability to the connection between the center pole 12 and the tree-top 46 and a safety covering over the plug 78. The sleeve 82 prevents the plug 78 from being unplugged by a child, pet, or someone unaware of the hazards, both electrical and physical, that may be encountered if removing the plug 78 without supervision. In addition, the sleeve 82 prevents a child from inserting fingers or other small objects into the plug 78. Wiring within the plug 78 extends therefrom and provides power to a light string about the tree-top 46 through a receiving fusible link plug 86 which received a fusible link plug 88 on the light string 34 about the tree-top 46.

Although preferred embodiments of the invention have been illustrated in the accompanying Drawings and described in the foregoing Detailed Description, it will be understood that the invention is not limited to the embodiments disclosed, but is capable of numerous rearrangements, modifications, and substitutions of parts and elements without departing from the spirit of the invention.

1. An illuminated artificial tree comprising:
a center pole;
a plurality of branches positioned about the center pole, each branch comprising a single string of electrical lights mounted thereon;
a plurality of mounts secured on the center pole, each mount for supporting a plurality of branches with the branches being positioned at spaced apart intervals about the center pole;
each mount comprising a plurality of cavities, each cavity for removably receiving one of the branches;
means within each cavity for providing electricity to the string of lights of the branch associated therewith so that the string of lights can be replaced without affecting other strings of lights on other branches; and
means for providing electricity within the center pole and into the cavities of the mounts.

2. The tree according to claim 1 wherein the center pole comprises a bottom portion and a top portion coupled together by a plug, the plug received into a female receiver having a sleeve extending therearound.

3. The tree according to claim 1 wherein the means for providing electricity within the center pole is a power cord system, the power cord system comprising a plurality of power cords and wires.

4. The tree according to claim 1 wherein the means within each cavity for providing electricity to the string of lights comprises electrical contacts within each cavity connected to the means for providing electricity within the center pole; electrical contacts on one end of each branch; and wiring extending from the electrical contacts on the branch to a light string receiving plug for receiving a fusible link plug on the string of lights about the branch.

5. The tree according to claim 1 wherein each branch comprises a proximal and distal end, the proximal end comprising a boot incorporated thereon for engaging the branch into the cavity of the mount.

6. The tree according to claim 5 wherein the boot comprises electrical contacts for engaging receiving electrical contacts within the cavity connected with the means for providing electricity within the center pole, wiring extending from the electrical contacts of the boot to a light string receiving plug for receiving a fusible link plug on a string of lights strung about the branch.

7. The tree according to claim 5 wherein the boot is removably coupled with the proximal end of the branch.

8. An illuminated artificial tree, comprising:
a center pole;
a plurality of branches positioned about the center pole, each branch comprising a proximal and distal end, and a single string of electrical lights mounted thereon;
a plurality of mounts secured on the center pole, each mount for supporting a plurality of branches with the branches being positioned at spaced apart intervals about the center pole;
each mount comprising a plurality of cavities, each cavity for removably receiving one of the branches;
a power cord system within the center pole comprising a plurality of power cords and wires for providing electricity within the center pole and into the cavities of the mounts;
electrical contacts within each cavity receiving power from the power cord system and transferring power to electrical contacts on the proximal end of each branch such that a string of lights associated therewith can be replaced without affecting other strings of lights on other branches; and
a light receiving plug coupled with the electrical contacts on the proximal end of the branch for receiving a fusible link plug on one end of the string thereby providing electrical power to the string of lights.

9. The tree according to claim 8 wherein the center pole comprises a bottom portion and a top portion coupled together by a plug, the plug received into a female receiver having a sleeve extending therearound.

10. The tree according to claim 8 wherein each branch comprises a proximal and distal end, the proximal end comprising a boot incorporated thereon for engaging the branch into the cavity of the mount.

11. The tree according to claim 10 wherein the boot comprises electrical contacts for engaging receiving electrical contacts within the cavity connected with the means for providing electricity within the center pole, wiring extending from the electrical contacts of the boot to a light string receiving plug for receiving a fusible link plug on a string of lights strung about the branch.

12. The tree according to claim 10 wherein the boot is removably coupled with the proximal end of the branch.
